(19) United States
(12) Patent Application Publication
(10) Pub. No.: US 2004/0072524 A1
(43) Pub. Date: Apr. 15, 2004

(54) Transport device for elongate meat products and method for compensating length changes in a displacing member

(75) Inventors: Wilhelmus J.E.M. Van Den Dungen, Veghel (NL); Sigebertus J.J.J. Meggelaars, Eindhoven (NL); Roel J.W. Schenk, Wijchen (NL)

Correspondence Address: ZARLEY LAW FIRM P.L.C., CAPITAL SQUARE, 400 LOCUST, SUITE 200, DES MOINES, IA, 50309-2350, US

(73) Assignee: Townsend Engineering Company, Des Moines, IA

(21) Appl. No.: 10/643,021

(22) Filed: Aug. 18, 2003

Related U.S. Application Data
(60) Provisional application No. 60/409,853, filed on Sep. 11, 2002.

(30) Foreign Application Priority Data
Aug. 22, 2002 (NL) 1021316

(51) Int. Cl. A22C 11/00

(52) U.S. Cl. 452/51

(57) ABSTRACT

A transport apparatus for lying transport of elongated meat products has at least one endless displacing member for advancing product carriers. The displacing member is moved in a frame by a driver. The endless displacing member is driven at two separate positions. Tensing elements are placed between the separate positions of the drives.

### CROSS REFERENCE TO RELATED APPLICATION

This application is a continuation of U.S. Provisional Serial No. 60/409,853 filed Sep. 11, 2002 which is based upon Dutch application No. 1021316 filed Aug. 22, 2002.

### FIELD OF THE INVENTION

The invention relates to a transport device for elongate meat products which are subjected to a processing, comprising at least one endless displacing member for advancing product carriers, which displacing member is advanced in a frame by means of a drive. The invention also relates to a method for compensating length changes in a displacing member forming part of such a transport device for elongate meat products.

### BACKGROUND OF THE INVENTION

The processing of elongate meat products while they are being displaced in a transport device is known. That use is herein made of an endless displacing member, such as for instance a conveyor belt or chain which is driven using a motor, is likewise known. Reference is made in this respect to, among others, International patent application WO 99/13729, wherein the problem of the relatively heavy loading of the displacing member is partly resolved by providing guides with which the product carrier is supported in a manner other than by the displacing member. Despite the invention described in this document, it remains a problem to manufacture transport devices of a greater length. In the International patent application a solution for transport over greater length is presented by providing an integrated transport device with at least two separate transport devices connecting onto each other. Placed between the separate transport devices is a transferring means with which the elongate meat products can be transferred from a first transport device to a second transport device. However, the presence of a transferring means has considerable drawbacks, such as, among others, the possibility of failure or other problems during transfer. In addition, a transferring means is bulky and expensive.

U.S. Pat. No. 6,086,469 describes a method and device for suspended transport of strands of sausage. A horizontally disposed endless conveyor is provided with hooks from which the strands can be suspended in order to transport the strands from a loading station along a first section of the transport path to a processing station such as a smoking room. From the processing station the transport path leads back to the loading station by means of a second section. The first and the second sections do not herein run symmetrically. Also described is that a motor for moving the conveyor can be supported by a plurality of support motors, in order to thus reduce the tensions in the chain. The suspended transport of elongate meat products such as strands of sausage differs expressly from lying transport of elongate meat products; wherein a reduction in the volume of the conveyor is of much more significance, partly due to the fact that it must usually be possible to position parallel one above the other a plurality of parts of the transport path which run more or less parallel to each other The present invention has for its object to furnish provisions with which a transport device for lying transport of elongate meat products can be realized of very great length (for instance lengths of more than 100 metres), with only one endless displacing member, without this displacing member having to take an excessively heavy form and without the necessary presence of a complex measuring and control mechanism to make the transport device function.

A further object of this invention is to give the conveyor, for instance a chain, a relatively heavy form, so that fewer problematic length changes of the conveyor will occur than in a transport device.

### SUMMARY OF THE INVENTION

The invention provides for this purpose a transport device of the type stated in the preamble, characterized in that the endless displacing member is driven at least at two placed-apart positions and tensioning means for the displacing member are placed between the drives. The displacing member will be loaded less heavily locally at the drive when a plurality of drives engage on the displacing member at placed-apart positions. This makes it possible to limit the maximum load on the displacing member, even in the case of extremely long displacing members (theoretically endlessly long), which has the advantage that relatively long (more than 100 or 50 metres) displacing members can also take a structurally light form. In the case of displacing members of a greater length problematic length changes can occur, for instance as a result of wear, temperature changes, or varying loads. Tensioning means are provided to enable these changes in the length of the displacing member to be compensated.

In a preferred embodiment of the transport device the tensioning means are provided with detecting means for monitoring the functioning of the tensioning means, and the detecting means are connected to an adjacent drive along the displacing member for controlling the drive subject to the functioning of the tensioning means. When local tensioning means must compensate relatively large length changes of the displacing member, these length changes can approximate the limits of the working range of the tensioning means. When other tensioning means have not yet reached the limits of the control range, or when the length of the displacing member is deliberately changed (for instance manually shortened or lengthened), it is advantageous when at least a part of the compensated length change of specific tensioning means is transmitted to other tensioning means or to the location where the deliberate length change takes place. This becomes possible without a complex central control when the detecting means of determined tensioning means are coupled to a nearby drive (located before or after the tensioning means in transport direction) such that the operation of the drive is influenced when predetermined compensation values are reached. Only a coupling of tensioning means to a single drive is a technically simple solution which is not very susceptible to malfunction and which does not have to be expensive. In a specific preferred variant the tensioning means are connected to the subsequent drive in the direction of transport of the displacing member. By causing the subsequent drive to operate in accelerated respectively decelerated manner the length variations can be transmitted in forward direction.

In a specific preferred variant the transport device is provided with a central control of the drives, to which central control are connected the detecting means of the tensioning means. Although the complexity of the transport device is increased with such a central control, the adjustment options also increase.

The tensioning means preferably comprise a guide displaceable under bias for the displacing member, and the position of the displaceable guide can preferably be detected by means of a sensor. The guide can for instance be formed by a reversing roller or a (chain) wheel pressing against the displacing member with a determined force. When the force exerted on the displacing member by the displaceable guide is held substantially constant, the guide will displace subject to the length changes occurring locally in the displacing member. Such a construction can be realized very simply. A simple optical sensor with little susceptibility to disturbance can for instance be applied as sensor.

The drying of semi-manufactures for dry sausage, not manufactured by means of co-extrusion, still takes place today in suspended state. A plurality of strands not yet mutually separated are herein suspended from rods or bars. Meat products manufactured by means of extrusion (including sausages) are dried on racks. The necessity of using racks lay in the fact that the elongate meat products, in already shortened form, had to remain in a drying room for a longer period of time (more than twenty-four hours), which would necessitate a transport device with a length which could not be realized economically. The present invention however makes it possible to provide, at a competitive price, a transport device which is also sufficiently long for this application. For this purpose the present transport device is at least substantially disposed in a climate room.

In a relatively simple embodiment variant of the transport device which is also not very susceptible to failure, the displacing member is formed by a chain. In order to limit the volume of the chain as much as possible, steel with good mechanical properties (a high material strength is particularly important) is preferably used. Even when the choice of material for the chain has the lesser property that the chain is not sufficiently corrosion-resistant, it can be advantageous to opt for minimizing the volume rather than for a greater corrosion resistance. Another important reason for giving preference to a high material strength in the choice of material is that the number of motors driving the chain can hereby be limited. This becomes possible by applying a corrosion-inhibiting agent such as for instance Teflon, for instance by means of optionally continuous vaporizing or spraying on the chain, at a determined location in the transport path.

For the transport of product carriers in a more or less horizontal position it is advantageous when the transport device comprises at least two displacing members running parallel and supporting the product carriers. Favorable results for supporting elongate meat products, such as in particular sausages, can be obtained with product carriers in the form of elongate baskets which are formed at least partly from a material provided with mesh. A very large part of the surface of the products for processing can undergo a surface treatment through the mesh. Particularly envisaged here is the drying of sausages.

For a good support of the displacing member with a limited resistance, it is favorable when the displacing member is displaceable in the frame via rotatable guide means.

In order to obtain the most compact possible disposition of the transport device with a great length, in a preferred embodiment the displacing member is moved in the frame such that the displacing member contains a plurality of parts running substantially parallel to each other, wherein adjacent parts move in opposite directions. These parts or sections of the transport path can thus be positioned a short distance one above the other, which is possible among other reasons because of the limited volume of the displacing member which can be realized as a result of the present invention. In practice, the drives will normally be formed by motors such as electric motors, hydraulic motors or pneumatic motors.

The transport device can also be provided with warning means which are coupled to the detecting means and which are activated when a determined control limit of the tensioning means is exceeded. The detecting means can thus also be used to indicate for instance breakage of the displacing member, or a change in length of the displacing member such that the length must be adjusted (for instance when the length increases) by manually removing a part of the displacing member.

The invention also comprises a method of the type stated in the preamble, comprising the operating steps of a) monitoring the functioning of the tensioning means by means of the detecting means, and b) controlling a drive, subject to the monitored functioning of the tensioning means, such that functioning of the tensioning means falls within a determined control range. Such a method enables adjustment of the tension of a displacing member using simple means. Complex measures such as pulse generators, encoders and complex automated regulating means are unnecessary, although they can be combined with the present invention if desired. When the tensioning means exceed a control limit the detecting means preferably generate a signal, on the basis of which the length of the displacing member is adjusted. In this manner a more stable operation is created in the adjustment of the tensioning means; only at moments when this is actually necessary is the adjustment set into operation, while during the greater part of the operating time the tensioning means individually compensate length changes which occur.

### BRIEF DESCRIPTION OF THE DRAWINGS

FIG. 1 shows a side view of a transport device according to the invention;

FIG. 2 shows a side view of an end surface of the transport device of FIG. 1;

FIG. 3 is a perspective view of a part of the transport device shown in FIGS. 1 and 2; and

FIG. 4 shows a detail view of a sensor unit coupled to a displaceable reversing roller for determining the position of the reversing roller.

### DESCRIPTION OF THE EMBODIMENTS OF THE INVENTION

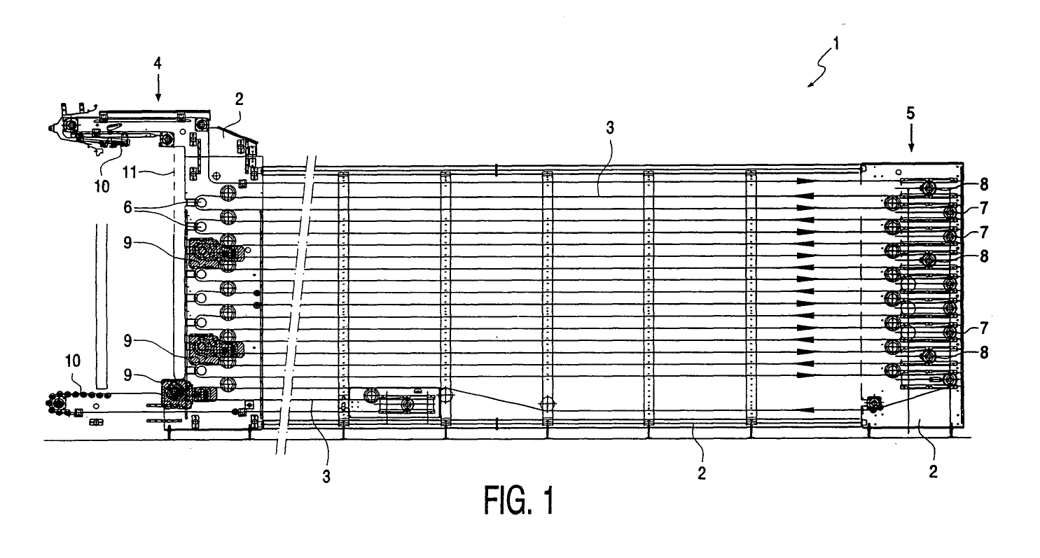

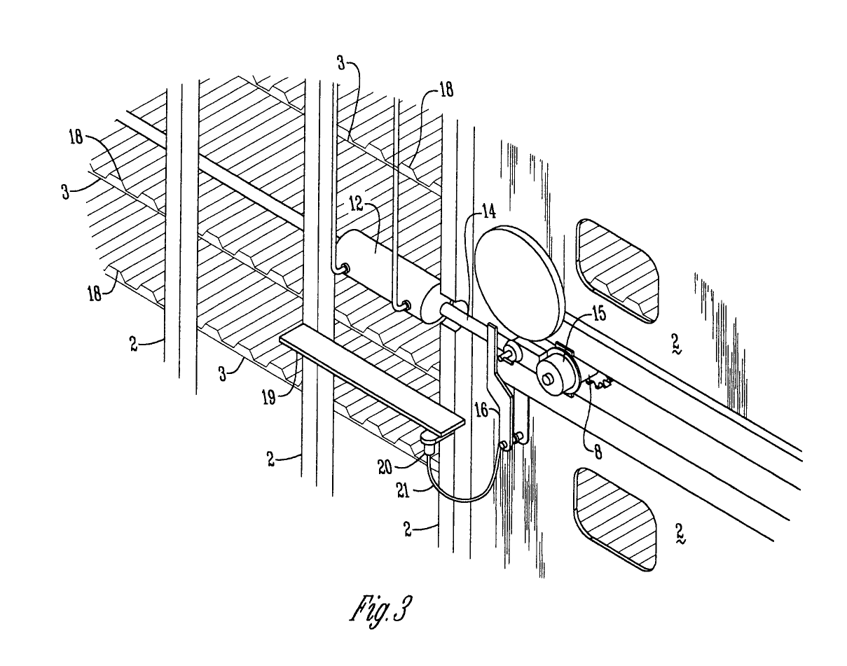

FIG. 1 shows a transport device 1 with a frame 2 in which is arranged an endless chain 3 shown schematically by means of a broken line. Not visible in this figure is a second chain which runs parallel to chain 3 and which runs wholly parallel behind the shown chain 3. Product carriers are suspended between these chains, for which reference is made to FIG. 3. On both end surfaces 4, 5 of frame 2 are respectively arranged reversing rollers 6, 7, 8 for guiding of chain 3. Reversing rollers 6 on the first end surface 4 are mounted in frame 2 at fixed positions and reversing rollers 7 on the second end surface 5 are also mounted in frame 2 at fixed positions. Reversing rollers 8 are however displaceable in frame 2 such that they are pressed outward with a determined bias (to the right in the figure). For displacing of chain 3 there are there motors 9 placed in frame 2, which engage on chain 3 at placed-apart positions to thus reduce the tensions in chain 3. Also shown schematically are the loading and unloading means 10 for loading transport device 1 with elongate meat products and, after these have passed through the whole transport path, unloading transport device 1. Loading and unloading means 10 are disposed at the position of a vertical part 11 of chain 3; this vertical chain part 11 is present to make chain 3 into a closed, endless construction. One of the motors 9 engages on vertical chain part 11. Motors 9 are placed relative to chain 3 such that, after a determined position on chain 3 passes a motor 9 as this determined position runs through the transport path, this position first passes a reversing roller 8 before a subsequent motor 9 is reached. Transport device 1 makes it possible to accommodate an endless chain 3 of a considerable length in a relatively compact housing. It hereby becomes possible to also carry out longer treatment processes as a continuous process, such as for instance the drying of sausages (for which purpose a large accommodation capacity for products is required due to the length of the treatment).

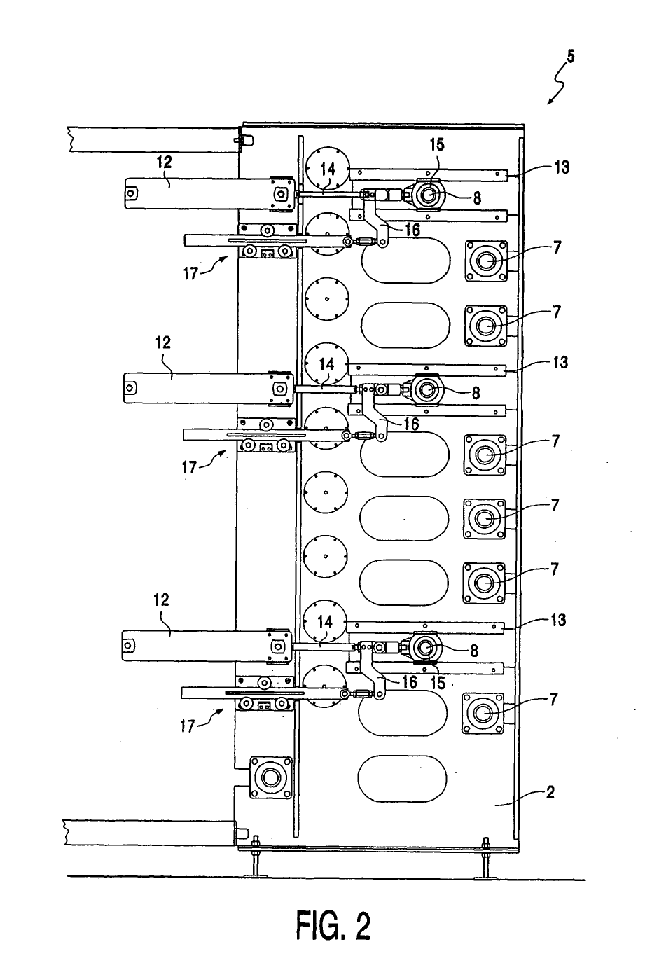

FIG. 2 shows end surface 5 of frame 2 of FIG. 1 in more detail. In addition to the reversing rollers 7 placed in frame 2 at a fixed position on the second end surface 5 can also be seen the reversing rollers 8 which are displaceable along guides 13 by means of pressure cylinders 12. For this purpose a piston rod 14 of pressure cylinder 12 engages on rotation shaft 15 of displaceable reversing roller 8. In order to determine the position of displaceable reversing rollers 8 the piston rod 14 is provided with an arm 16 with which it drives a sensor unit 17. A sensor unit 17 is shown in more detail in the following figures.

FIG. 3 shows a perspective view of a part of transport device 1. It can be seen here that chain 3 engages on product carriers 18 which are manufactured from a material with a mesh-like structure. Connected to frame 2 is the pressure cylinder 12 which engages with piston rod 14 on rotation shaft 15 of reversing roller 8 (in this specific case a chain wheel). It should be apparent that in frame 2 a parallel placed chain advances the non-visible sides of product carriers 18. This chain (not shown) is also provided at the corresponding position with a displaceable chain wheel 8 such as the one shown. Arm 16 of piston rod 14 displaces a strip of material 19 which is embodied such that a surface thereof for detecting encloses an acute angle with the displacing device of material strip 19. An optical sensor 20 can thus be used to determine the distance to the surface for detecting of material strip 19. The signal of sensor 20 is fed back to an adjacently placed motor 9 (not shown) by means of a signal line 21.

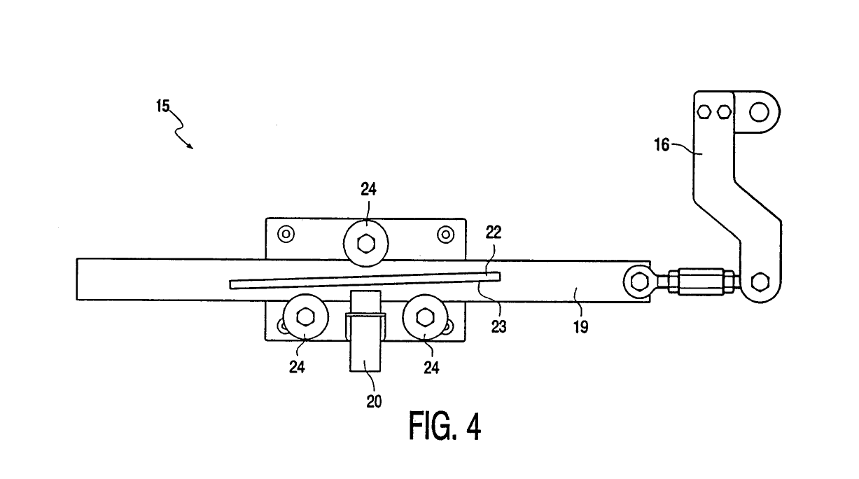

FIG. 4 finally shows a detail view of a sensor unit 15 which is coupled to a displaceable reversing roller 8 for determining the position of reversing roller 8. Arm 16 engages on the displaceable material strip 19. This material strip 19 is provided with a standing edge 22 with a surface 23 which encloses an acute angle with the displacing device of material strip 19. When material strip 19 is displaced, the distance between surface 23 and sensor 20 varies, which can be detected. The material strip 19 is guided by three guide wheels 24.

The operation of the invention, described in the foregoing summary of the invention, in view of the above description, makes it clear that this invention will achieve at least all of its stated objectives.

We claim:

1. A transport device for lying transport of elongate meat products which are subjected to a processing, comprising
at least one endless displacing member for advancing product carriers, which displacing member is advanced in a frame by means of a drive, characterized in that the endless displacing member is driven at least at two placed-apart positions and tensioning means for the displacing member are placed between the drives.

2. The transport device as claimed in claim 1, characterized in that the tensioning means are provided with detecting means for monitoring the functioning of the tensioning means, and the detecting means are connected to an adjacent drive along the displacing member for controlling the drive subject to the functioning of the tensioning means.

3. The transport device as claimed in claim 2, characterized in that the tensioning means are connected to the subsequent drive in the direction of transport of the displacing member.

4. The transport device as claimed in claim 2, characterized in that the transport device is provided with a central control of the drives, to which central control are connected the detecting means of the tensioning means.

5. The transport device as claimed in claim 1, characterized in that the tensioning means comprise a guide displaceable under bias for the displacing member, and the position of the displaceable guide is detected by means of a sensor.

6. The transport device as claimed in claim 5, characterized in that the sensor is an optical sensor.

7. The transport device as claimed in claim 1, characterized in that the displacing member is a chain.

8. The transport device as claimed in claim 1, characterized in that the transport device comprises at least two parallel running displacing members, wherein the product carriers are supported by a plurality of displacing members.

9. The transport device a claimed in claim 1, characterized in that product carriers comprised of elongate baskets are formed at least partly from a mesh material.

10. The transport device as claimed in claim 1, characterized in that the displacing member is displaceable in the frame rotatable guide means.

11. The transport device as claimed in claim 1, characterized in that the displacing member is moved in the frame such that the displacing member contains a plurality of parts running substantially parallel to each other, wherein adjacent parts move in opposite directions.

12. Transport device as claimed in claim 1, characterized in that the drive is a motor drive.

13. A transport device as claimed in claim 1, characterized in that the transport device is provided with warning means which is coupled to detecting means which is activated when a determined control limit of the tensioning means is exceeded.

14. A method for compensating length changes in a transport device having a tensioning means, a detecting means, a control drive, and a displacing member forming part of the transport device for elongate meat products, comprising the operating steps of:
a) monitoring the functioning of the tensioning means by means of the detecting means, and
b) controlling a derive, subject to the monitored functioning of the tensioning means, such that functioning of the tensioning means falls within a determined control range.

15. The method as claimed in claim 14, characterized in that when the tensioning means exceeds a control limit, the detecting means generate a signal, on the basis of which the length of the displacing member is adjusted.
